(19) United States
(12) Patent Application Publication
(10) Pub. No.: US 2006/0052057 A1
(43) Pub. Date: Mar. 9, 2006

(54) Group codes for use by radio proximity applications

(76) Inventors: Per Persson, Helsinki (FI); Younghee Jung, Helsinki (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(21) Appl. No.: 10/934,754

(22) Filed: Sep. 3, 2004

(51) Int. Cl. H04B 7/00

(52) U.S. Cl. 455/41.2

(57) ABSTRACT

A wireless communication device (11) including a proximity application (11c) using a short-range radio link and using group codes (11d) for a simple determination of potential common interests with users of correspondingly configured wireless communication devices (12). The group codes (11d) indicate membership in a group of people having at least one common attribute or interest.

### TECHNICAL FIELD

The present invention pertains to the field of proximity radio communication. More particularly, the present invention pertains to the exchange of information between communication devices via short-range radio so as to determine in a discreet way whether users of the respective devices both belong to one or more predetermined groups.

### BACKGROUND ART

Lately there has been an emerging interest in proximity applications, i.e. applications enabling mobile devices to form (social) networks using local, i.e. short-range or proximity radio such as Bluetooth. Since for short-range radio works only when the communicating devices are proximate (e.g., in the case of BT range is limited to a maximum of approximately 15 meters), proximity applications could potentially provide more information about co-located non-acquaintances and even ‘recommend’ a non-acquainted person nearby. Some market analysts have observed that the interaction provided by proximity applications seem to offer a ‘social thrill’ (maybe in large part due to such interactions being free-of-charge) and so are in demand, and thus proximity applications fulfill an unmet need.

Providing information about co-located non-acquaintances can be accomplished in many ways according to the prior art. A simple way is what can be called ‘local browsing,’ which requires that users create ‘mobile web pages’ that can be broadcast to, or accessed by, proximate users, with or without the owner's awareness. The concept of mobile web pages is analogous to that of Internet homepages where it is basically up to each participant to determine what information to publish and what level of detail to provide. The browsing device is typically restricted to presenting information; it typically does not act in response to the information.

A more sophisticated method is provided by applications that compare data on two devices linked e.g. by means of short-range radio, and then determine if there is a social match (overlap) indicated in some way, even including whether the user of one of the devices is looking for something that the user of the other is able to provide. Such proximity applications can provide interaction between proximate users based on various forms of data/information structures and even installed applications.

One data/information structure is a so-called information profile, typically including a plurality of fields, each field including a series of attributes where each attribute is defined by a name, a type, and a value. (e.g., NAME; STRING; John Doe; AGE; INTEGER; 33; . . . ). If the communicating devices use the same information profile structures, the respective proximity applications can search the profiles of each other, and in case of finding a match to a search criteria pre-specified by either user, display the respective profiles of the two users, and so users can learn about each other—their interests, preferences, and so on—by viewing the respective profiles.

Another way for the proximity applications to provide social interaction is based on whether the devices hosting the respective proximity applications also host one or more same other applications, applications such as games. The proximity applications discover the common applications based on a discovery process. Typically such discovery is followed by automatic connection of the two applications in order to exchange information or allow interaction between them. Multi-player games are a good example, and discovery of two non-acquainted players in public places is then possible.

Yet another way is via data items stored inside applications and databases. Such interaction is based not only on common applications, but also on data or information items stored in the applications. The participating users could, for instance, compare items stored in lists of contacts in e.g. an address book, or lists of items stored in respective web browsers (i.e. lists of bookmarks), items in call and message logs, items stored in media applications (e.g. music and video files), items stored in proximity applications (e.g. people that has connected to my phone via BT) and other items. Such comparison may reveal what the two participating users have in common. For example, a phonebook match may suggest common acquaintances; a music file match may indicate a shared music taste; a URL match may suggest shared interests or preferences; and phone log matches and encounter matches may reveal that the two users tend to communicate with the same third user. Since the comparison involves personal data, consent from both parties is typically sought by the proximity applications. To further alleviate privacy concerns, only commonalities are shown to the two users by the respective proximity applications, instead of showing all information items stored in the applications on the other device.

There are pros and cons in each of the above-described approaches for providing motivations for social interaction via proximity applications. Although the use of profiles provides a sophisticated possibility for displaying to others—and searching for—information about co-located people, it also requires that users manually provide and update information in the profiles and also specify search criteria. The burden on the user can be, for many users, too great. By contrast, the other two ways—using common applications and using data stored in applications—do not involve any management of data required in particular for the proximity applications, but they do not allow users to express themselves to others or be creative with what they want to match or disclose.

At the other extreme is the local browsing, enabling a user to tailor what to express to others, but the information presented is not made use of by the proximity applications of nearby users. For instance, in contrast to an information-comparison proximity application for which a user explicitly inputs information with the intent that it be used for comparison with information input by others in corresponding respective applications, a local browsing application would typically not guide a user to author information for comparison by other applications, and thus cannot provide comparison results. Instead, a local browsing application would provide only a search function that would find specific information specified by the user.

Thus, what is needed is a way of providing for information-comparison that strikes a balance between the different ways provided by the prior art, and in particular eliminates or reduces any requirements imposed on a user of a proximity application--such as creating and maintaining search criteria, or creating and maintaining a profile—in order for the user to experience the socializing advantage of proximity applications.

### DISCLOSURE OF THE INVENTION

Accordingly, in a first aspect of the invention, a wireless communication device is provided, comprising: a proximity application, responsive to a code indicating membership in a group and received from another wireless communication device, for providing an indication the code has been received if the code is the same or similar to a code stored in the wireless communication device; and a short-range communication module, for receiving the code from the other wireless communication device via short-range radio communication with the other wireless communication device.

In accord with the first aspect of the invention, the wireless communication device may further comprise means for determining whether the code stored in the wireless communication device is the same as a code in a data store on a server accessible to the wireless communication device. Also, the wireless communication device may further comprise means for enabling a user to determine or for automatically determining whether the code stored in the wireless communication device represents the same group as a same code in a data store on a server accessible to the wireless communication device.

Also in accord with the first aspect of the invention, the wireless communication device may further comprise means for comparing one or more received codes to one or more codes stored in the wireless communication device and for providing an indication in case of an overlap of the received codes and the stored codes.

Also in accord with the first aspect of the invention, the wireless communication device may further comprise means for indicating the overlap.

In a second aspect of the invention, a system is provided, comprising a plurality of wireless communication devices as in the first aspect of the invention, and further comprising a server accessible to the wireless communication devices, for storing codes each indicating a respective group of people or other entities based on a common attribute or interest.

In accord with the second aspect of the invention, at least one of the wireless communication devices and the server may each adapted so as to enable the wireless communication device to determine whether a code stored in the wireless communication device is the same as at least one code stored in the server, and so as to enable either the wireless communication device or a user of the wireless communication device to determine whether the code stored in the wireless communication device represents the same group as the same code stored in the server.

In a third aspect of the invention, a method is provided, comprising: a step in which a short-range communication module of a first wireless communication device receives from a second wireless communication device via short-range radio communication a code indicating membership in a group; and a step in which a proximity application hosted by the first wireless communication device, in response to the code, provides an indication that the code has been received if the code is the same or similar to a code stored in the first wireless communication device.

In accord with the third aspect of the invention, the method may further comprise a step of determining whether the code stored in the wireless communication device is the same as a code in a data store on a server accessible to the wireless communication device.

In a fourth aspect of the invention, a computer program product is provided comprising a computer readable storage structure embodying computer program code thereon for execution by a computer processor in a first device, wherein said computer program code includes instructions for performing a method according to the third aspect of the invention.

### BRIEF DESCRIPTION OF THE DRAWINGS

The above and other objects, features and advantages of the invention will become apparent from a consideration of the subsequent detailed description presented in connection with accompanying drawings, in which:

FIG. 1 is a block diagram of a mobile phone according to the invention and so having a data store of group codes (typically only one group code is stored in the data store) for use by a proximity application hosted by the mobile phone, and showing short-range and other communication links to another mobile phone and also a communication link (optional) to a server (e.g. via a browser) hosting possibly standardized group codes.

FIG. 2 is a flow chart showing a method of operation of a proximity application hosted by the mobile phone of FIG. 1, and so using group codes to identify the other, nearby mobile phone of FIG. 1.

### DETAILED DESCRIPTION OF THE INVENTION

The invention is here described in connection with use by a mobile phone. But as should be clear from the description, the invention is of use by any kind of mobile communication device, including for example a personal communication system, or even a (portable) laptop computer hosting cellular telephone capability, as long as the mobile communication device includes short-range (local) radio functionality.

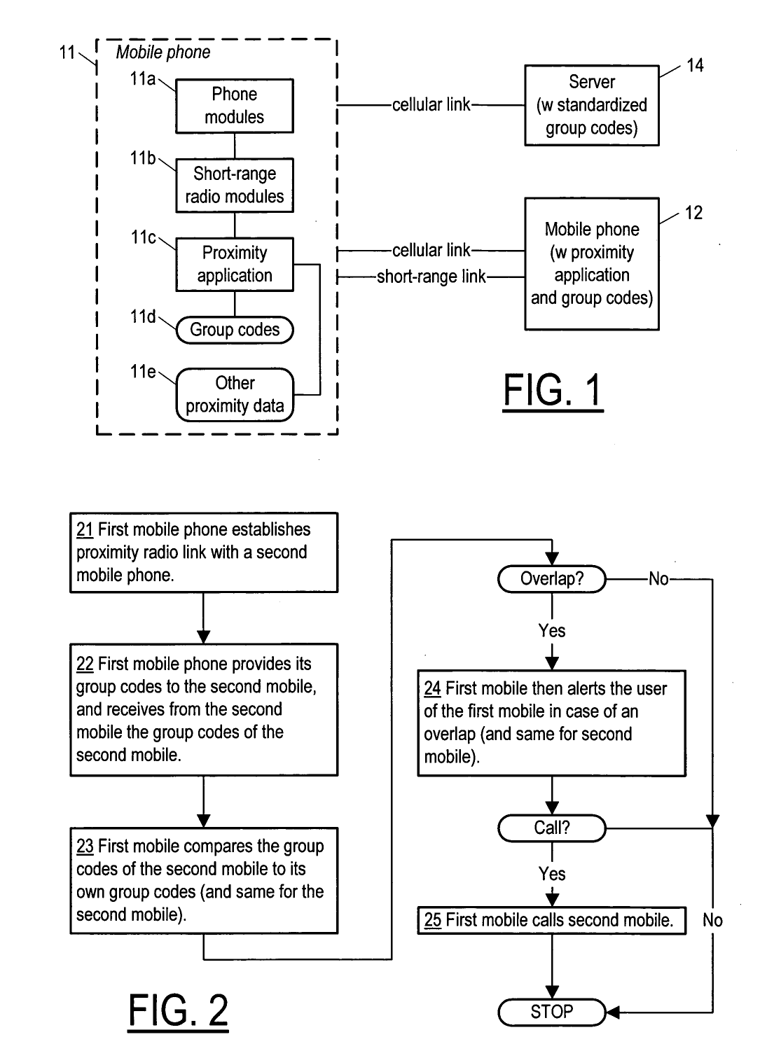

Referring to FIGS. 1 and 2, in a first step 21 according to the invention, a first mobile phone 11 hosting a proximity application 11c establishes a proximity/short-range radio link with a second mobile phone 12 hosting a compatible proximity application (not shown). The first mobile includes short-range radio modules lib which it uses to establish the short-range link. In a next step 22, the proximity application 11c of the first mobile phone 11 provides to the second mobile 12 what are here called a group code indicating membership in some group (or class or community) (e.g. the class of all hikers), stored in a group code data store 11d in the first mobile, and receives from the second mobile a group code stored in the second mobile. In a next step 23, the two mobiles compare the respective group codes received from the other. In case of an overlap (of the one or possibly more group codes), in a next step 24, each then alerts the respective user. In case of more than one group code per mobile device, the alert typically includes a description of the overlap, i.e. an indication of which group codes are the same. (The alert can be embedded in some other process in the proximity application, such as an icon on top of the user's pages of local browsing.) The user of each mobile then decides whether to initiate further communication, either via the proximity applications, via e.g. a cellular communication link, or face-to-face conversation as appropriate. Mechanisms for alerting a user can vary depending on the embodiment of the invention. For example, an alert could be given only to the initiating user. Or the alert could be given to the other user upon the discovery of the overlap based on the other user's preference.

Although the invention is especially simple and still highly useful with only a single group code stored in a mobile device, as indicated above the invention also encompasses having more than one group code per mobile device. With only one group code, in case a mobile device implementing the invention discovers another mobile device with the same group code, the mobile device need only indicate that another user device of the same group is nearby. In case of multiple groups, as mentioned above, upon discovering an overlap of group codes with those of another mobile device, an implementation of the invention must indicate the extent of the overlap.

There could be, however, various embodiments employing different methods for giving alerts to the user who initiates the group code match and the other user who is discovered in the match. As given in the above example, both users can be notified at the same time. In another embodiment, only the initiating user can receive the alert.

In an embodiment employing the use of a group code combined with the above-mentioned ‘local browsing’ system where any compatible application user can browse the content of other users' mobile pages, one may also need to consider the privacy of the group code. In order to make the discovery of the matching group code users more discreet, a group code match alert can be given as part of GUI (graphical user interface) of the local browsing of pages of the mobile phones of other users. In such a case, those mobile pages whose group codes do not match the browsing user's can be hidden. This way, the user is assured that only those who belong to the same group can find out which group the user belongs to. In an illustrative embodiment, there is no specific group code match alert given to a user; instead the user is able to see by means of graphical indication that certain of the users in the list of found users have the same group code. Also, to prevent other non-group members from seeing which group a user belongs to, the group code is not visible to other users who do not have the same group code.

To enable establishing a cellular link for further interaction, the first mobile phone 11 would include phone modules 11a, and similarly for the second mobile. (A voice cell phone call of course requires a cell phone number.) Other wireless longer-range or even short-range links of course could also be used for the further communication.

The invention facilitates further interaction after another user is found by the invention to be nearby. Thus, if the user of the first mobile 11 decides to place a call to the user of the other mobile 12 after the invention indicates to the user of the first mobile that the second mobile is nearby, then in response to a prompt from the proximity application 11c, the user of the first mobile commands the proximity application 11c to initiate e.g. a cell phone call to the other user, and in a next step 25 the proximity application 11c then initiates the call to the user of the other mobile 12 by communicating with the phone modules 11a of the first mobile according to methods not the subject of the invention. Prior to the step 25 of calling the second mobile, there is typically some handshaking—not the subject of the invention—between the proximity applications in the two mobiles, and also inputs by the respective users, to agree that further communication is desired, and which mobile is to place the call or otherwise establish a link for further communication.

Still referring to FIG. 1, as described more below the group codes—each typically consisting of a text string with a maximum length defined by the application that utilizes it—may be created independently but should be created according to some common understanding, even being standardized and available for referral on a server 14 accessible possibly via a wireless radio link. (Group codes can be standardized/defined by users in a totally open system, or by system organizers, but in the latter case, running the risk that some communities/groups will not feel that they can find and appropriate code for their group.) Further, the group codes may be to some extent systematized so that, e.g. part of the code represents a broad class, and more of the code represents a subset of the broad class. Thus, e.g. experienced hikers might have a group code of 33339, whereas all hikers would have as a code only the first four characters of the group code string for the experienced hikers, i.e. 3333. (In such an arrangement, there would have to be a person/organization/machine that would supervise the creation of codes. An alternative is to allow users to create any code they like, as described more below.)

Thus, the invention provides proximity applications that use group codes for expressing membership in a group or community or a class/set of people having at least one attribute in common, such as even simply nationality. The use of group codes imposes minimal burden on the user's part. The group codes typically target rather large communities or interest groups, dispersed geographically or so large that it is impossible to have met all members, particularly in situations where the need to identify people who belong to the same group arises. Typical examples would be Internet communities, ideological or religious communities, fan clubs, or national communities. The main common characteristic of such communities is that members may be linked together by their common interest or set membership, but are not typically acquainted by face-to-face encounters.

The group code matching according to the invention can be particularly simple in that only one list of group codes (or even a single group code) is used. There is no need to have both group codes characterizing the user—what might be called user group codes—and other group codes for use in searching for other users—what might be called search group codes, although the invention does encompass such embodiments as well. In single-group-codes embodiments, the user does not have one group code representing the user's identity and another different code for locating members belonging to a group the user does not belong to at the moment. Only the group code representing the user's identity is used. Thus, the invention accomplishes the same as profile matching/multiple group codes embodiments with only a single group code. As an example, ‘hiker searching for hiking guide’ requires, in a profile matching embodiment, defining a user group code of “hiker” and a search group code of “hiking guide.” However, the invention provides the same result by simply having a single group code set aside for ‘hiker searching for hiking guide.’

An embodiment of a proximity application according to the invention can offer the user a way to input as a group code any string of digits, letters or symbols into a field. The format of the code can differ depending on the implemented platform and application. Ideally, the format of the code should be limited only in terms of length of the text string. The code can also have no specified format. Such a free-format code approach allows users to create their own codes and define their own community groups, using codes that are perhaps suggestive. Any code that is not standardized or otherwise controlled, however, makes obtaining a meaningful match less likely, though it might provide a higher degree of freedom for users of small groups to create their own group code without having to register to a system or check for compatibility to a standard. (Instead of actually standardizing codes, the creation of new codes can be controlled simply by providing a single, publicly accessible data store that users can refer to when creating with a new group code.)

To prevent spurious matches (two different groups using the same code) and to increase the likelihood of a good match (members of the same group using different codes for the same group), standardized codes can be used, and as described above a central server (e.g. the server 14 shown in FIG. 1) can provide a list of all or an appropriate subset of such codes. The list can provide a label or description indicating the group the code is standardized to represent. (This is crucial; without labels/descriptions it is impossible for users to search for a group code and or know that a group code in fact represents the group sought to be represented by the code.) The central server could also provide an interface e.g., through the Internet so that users can submit their group code and have it verified to be unique. Also the central server could provide a look-up service, e.g. for users inputting a group code into a mobile phone (but also for use in other situations). A user could look up a group code from the central server via a PC or phone-base Internet browser, or via an interface to proximity applications, if available. Code search could be provided so as to make possible searching for a code based on keywords or phrases in the codes, code labels or descriptions stored with the group codes in the listing on the central server.

The central server could also allow dynamic creation of group codes: if a user is unable to find a group code for a group, the central server could allow the user to create a new group code, and provide a corresponding label or description.

The invention has been shown and described in case of mobile phones using proximity applications, in which case any further communication—undertaken in some embodiments in case of discovering a matching group code in a nearby mobile phone—could be voice communication (e.g. via cellular communication, but only in case the required cell phone number is known) or non-voice communication (such as via a data connection used by e.g. the so-called short message service (SMS), or via proximity connectivity). It should be understood though that the invention encompasses a proximity application hosted by other than mobile phones, and more specifically also encompasses proximity applications hosted by wireless communication devices that provide only non-voice communication.

As explained above, the invention provides a method and also corresponding equipment consisting of various modules providing the functionality for performing the steps of the method. The modules may be implemented as hardware, or may be implemented as software or firmware for execution by a processor. In particular, in the case of firmware or software, the invention can be provided as a computer program product including a computer readable storage structure embodying computer program code—i.e. the software or firmware—thereon for execution by a computer processor.

It is to be understood that the above-described arrangements are only illustrative of the application of the principles of the present invention. Numerous modifications and alternative arrangements may be devised by those skilled in the art without departing from the scope of the present invention, and the appended claims are intended to cover such modifications and arrangements.

What is claimed is:

1. A wireless communication device, comprising:
a proximity application, responsive to a code indicating membership in a group and received from another wireless communication device, for providing an indication the code has been received if the code is the same or similar to a code stored in the wireless communication device; and
a short-range communication module, for receiving the code from the other wireless communication device via short-range radio communication with the other wireless communication device.

2. A wireless communication device as in claim 1, further comprising means for determining whether the code stored in the wireless communication device is the same as a code in a data store on a server accessible to the wireless communication device.

3. A wireless communication device as in claim 1, further comprising means for enabling a user to determine or for automatically determining whether the code stored in the wireless communication device represents the same group as a same code in a data store on a server accessible to the wireless communication device.

4. A wireless communication device as in claim 1, further comprising means for comparing one or more received codes to one or more codes stored in the wireless communication device and for providing an indication in case of an overlap of the received codes and the stored codes.

5. A wireless communication device as in claim 4, further comprising means for indicating the overlap.

6. A system, comprising a plurality of wireless communication devices as in claim 1, and further comprising a server accessible to the wireless communication devices, for storing codes each indicating a respective group of people or other entities based on a common attribute or interest.

7. A system as in claim 6, wherein at least one of the wireless communication devices and the server are each adapted so as to enable the wireless communication device to determine whether a code stored in the wireless communication device is the same as at least one code stored in the server, and so as to enable either the wireless communication device or a user of the wireless communication device to determine whether the code stored in the wireless communication device represents the same group as the same code stored in the server.

8. A method, comprising:
a step in which a short-range communication module of a first wireless communication device receives from a second wireless communication device via short-range radio communication a code indicating membership in a group; and
a step in which a proximity application hosted by the first wireless communication device, in response to the code, provides an indication that the code has been received if the code is the same or similar to a code stored in the first wireless communication device.

9. A method as in claim 8, further comprising a step of determining whether the code stored in the wireless communication device is the same as a code in a data store on a server accessible to the wireless communication device.

10. A method as in claim 9, further comprising a step of determining whether the code stored in the wireless communication device represents the same group as a same code in a data store on a server accessible to the wireless communication device.

11. A method as in claim 8, further comprising a step of comparing one or more received codes to one or more codes stored in the wireless communication device and of providing an indication in case of an overlap of the received codes and the stored codes.

12. A method as in claim 8, further comprising a step of indicating the overlap.

13. A computer program product comprising a computer readable storage structure embodying computer program code thereon for execution by a computer processor in a first device, wherein said computer program code includes instructions for performing a method in turn comprising:
a step of comparing a code indicating membership in a group and received from another device is the same or similar to a code stored in the first device; and
a step of providing an indication that the code has been received if the code is the same or similar to a code stored in the first device.
